(19) United States
(12) Patent Application Publication
(10) Pub. No.: US 2016/0000192 A1
(43) Pub. Date: Jan. 7, 2016

(54) Brooch Device Having Function of Illumination

(71) Applicant: Hua-Cheng Pan, (US)

(72) Inventor: Chih-Liang Wang, Tainan City (TW)

(21) Appl. No.: 14/324,065

(22) Filed: Jul. 3, 2014

(51) Int. Cl. A44C 15/00; F21V 23/00; F21V 23/04; F21V 23/02; A44C 1/00; F21V 33/00

(52) U.S. Cl. CPC A44C 15/0015; A44C 1/00; F21V 33/0008; F21V 23/04; F21V 23/023; F21V 23/004; F21Y 2101/02

(57) ABSTRACT

A brooch device with function of illumination is provided. The brooch device comprises a brooch member with light emitting member and a housing. The housing is combined with the brooch member. A switch is configured to the brooch member for selectively energizing and de-energizing light emitting device. When the light emitting device inside the housing is activated, the brooch device can emit light for illuminating.

### TECHNICAL FIELD

The present invention generally relates to a brooch, more particularly, to a brooch device having function of illumination, which is embedded with light emitting device.

### BACKGROUND

Brooch is a common article for modern women to achieve an ornamentation purpose. It is well known to support a decorative article on the person by means of a retainer comprising a pin member, especially a brooch, carrying said article and a fastening device separably connectable to the pin member.

The type of fastener usually employed for a brooch resembles a safety pin. A hinge is provided at the rear of the brooch which serves as a support for the pin. The tip of the pin is retained in a safety device located opposite the hinge. The most common type of safety devices are the sliding fastener and the ball type safety fastener. The sliding fastener consists essentially of a sleeve provided with a lateral slot into which the pin is inserted and which is then closed by means of a spring-loaded slide. The ball type safety fastener differs from the sliding fastener principally in respect to its spherical shape. The slide is curved to match the spherical shape of the fastener and bridges a notch into which the pin is inserted.

As described above, the invention proposes a newly concept and function of brooch different from conventional brooch. Accordingly, there is a possibility that the invention's brooch is superior to prior art's brooch.

### SUMMARY

According to an aspect of the invention, it proposes a brooch device with function of illumination, comprising a brooch member with a fixing pin; a light emitting device fixed on the brooch member; a housing with transparent or translucent property surrounding the light emitting device; and a switch coupled to the light emitting device for selectively power on and power off the light emitting device.

In an aspect, the brooch device further comprises a decoration unit disposed on the housing. The light emitting device is a light emitting diode.

In another aspect, the brooch device further comprises a picture formed an inner surface or an outer surface of the housing bottom.

In one aspect, the brooch member comprises a circuit board disposed on a bottom portion of the brooch member, wherein the circuit board includes a control circuit for controlling the light emitting device.

In yet another aspect, the brooch device further comprises a buzzer disposed on top surface of the brooch member for coupling to the circuit board.

In one aspect, the brooch device further comprises a rock switch for coupling to the circuit board (control circuit). The rock switch is ball-rolling switch, vibration ball switch or contact type vibration switch.

In another aspect, the brooch device further comprises a music IC for coupling to the circuit board (control circuit).

In yet another aspect, the control circuit is an integrated circuit and is programmed with one or more patterns for flashing and/or maintaining illumination of the light emitting devices. The brooch member includes a battery compartment. A battery may be disposed on the battery compartment. A bottom cover may be combined with or detachable from the brooch member.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a perspective view of a brooch device having function of illumination fastened on an user according to the invention;

FIG. 2 and FIG. 3 illustrate an expanded view of a brooch device according to one embodiment of the invention;

FIG. 4 illustrates a perspective view of a fixing pin.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The present invention provides a brooch device having function of illumination, which is equipped with light emitting member. Purpose of the invention proposes a brooch device equipped with light emitting device capable of creating function of illumination. The brooch device comprises a brooch member having a light emitting member and a housing with transparent or translucent property surrounding the light emitting device. The housing may be a round shape or other suitable shape.

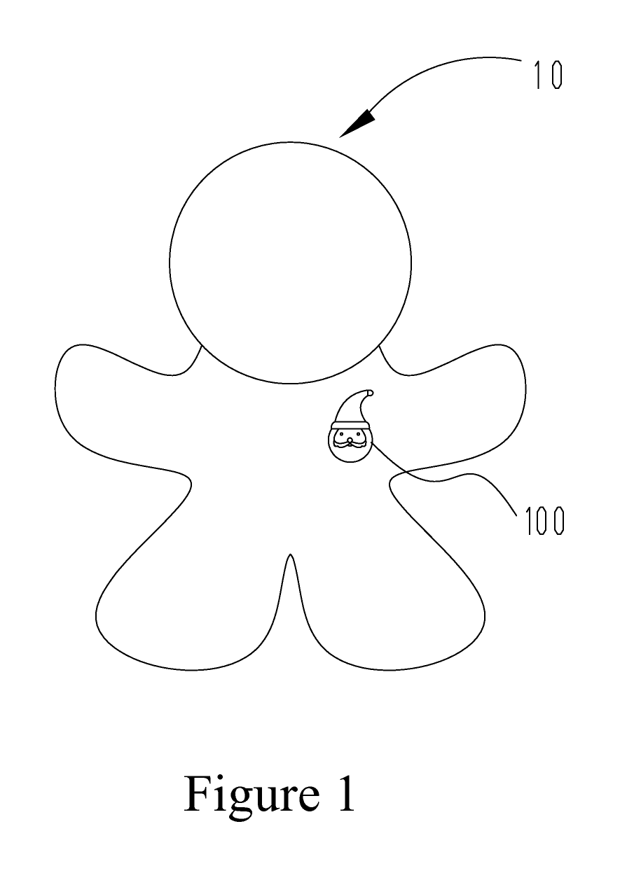

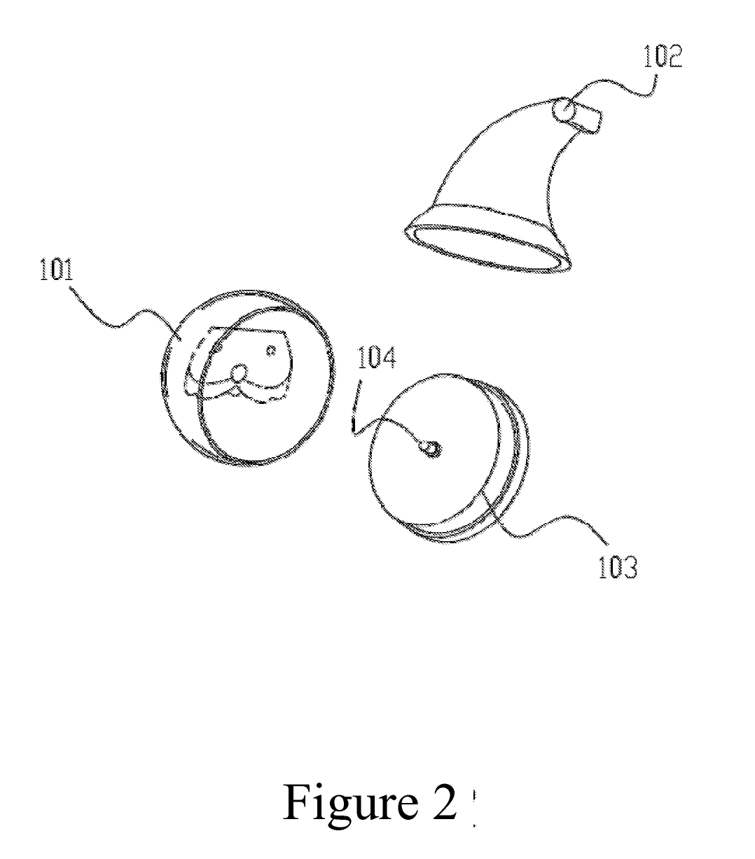

As shown in FIG. 1, a user 10 is wearing a brooch device 100. The brooch device 100 may be worn on clothing, garment of a mannequin or real person. As shown in FIG. 2, brooch device 100 includes a brooch member 103, light emitting device 104 fixed (disposed) on the brooch member 103 and a housing 101. The housing 101 has transparent or translucent property. The housing 101 is mounted on the brooch member 103. The light emitting device 104 may be fixed on the center or any position of top surface of the brooch member 103 for light emitting. The brooch device 100 further comprises a decoration unit 102 disposed on the housing 101. For example, the decoration unit 102 is made to be a desired pattern (figure), such as hat figure. The decoration unit 102 is fixed on the housing 101. In one embodiment, a picture may be formed inner surface or outer surface of the housing 101.

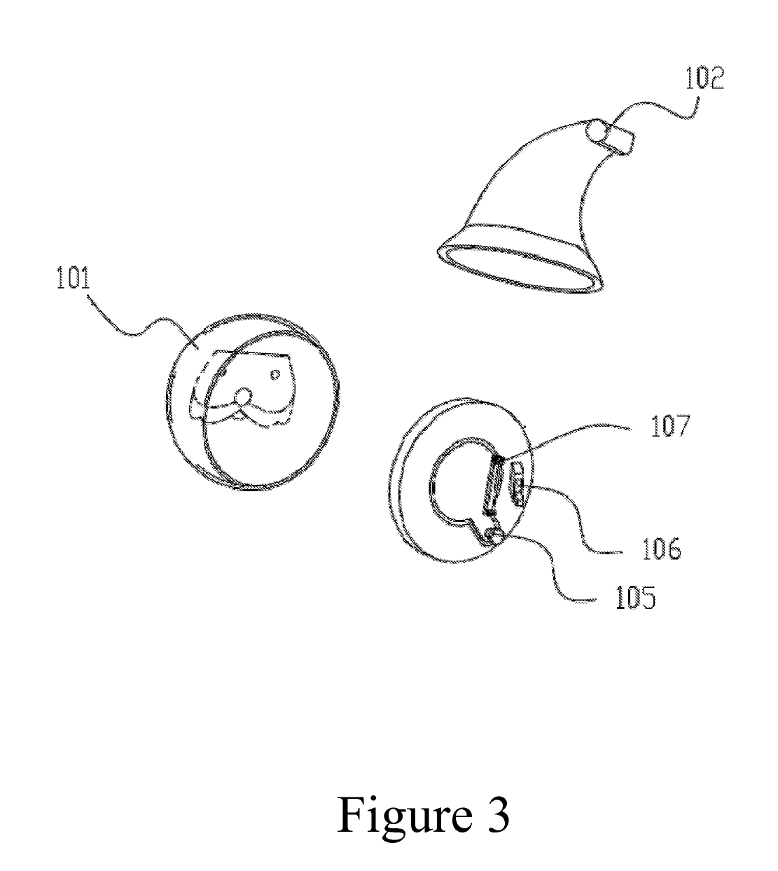

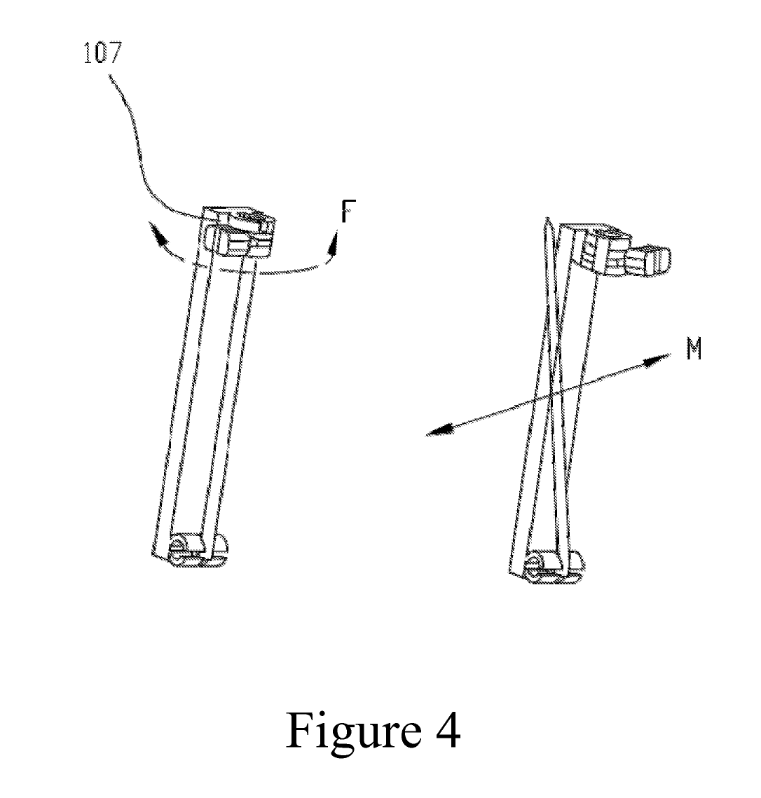

The brooch member 103 has a fixing pin 107 fixed on the bottom surface of the brooch member 103 for providing the brooch member 103 (brooch device 100) to be fixed, shown in FIG. 3. The pin of the fixing pin 107 can move along M-direction (left-right moving), and to be locked along F-direction (rotation) by a locking portion securely, shown in FIG. 4.

For example, the light emitting member 104 may include one or more light emitting diodes, or another type of light emitting unit or device.

The brooch member 103 includes a circuit board (not shown) and a switch 103, shown in FIG. 3. In one embodiment, the circuit board is disposed on an area of a bottom portion of the brooch member 103. In one embodiment, the circuit board is disposed within (internal) the housing of the brooch member 103. In one embodiment, the circuit board is coupled to light emitting device 104. In one embodiment, the circuit board includes a control circuit for controlling light emitting device 104. The light emitting device 104 is activated by the control circuit. The control circuit may be disposed/ configured on the circuit board. The circuit board is for example a printed circuit board. The switch 106 may be interposed between a power source and light emitting device 104, which is activatable by a user. The switch 106 may be coupled to side or bottom of the brooch member 103 for switching on/off state of the light emitting device 104. The circuit board is electrically connected to the power source, such as battery. In one embodiment, the circuit board is electrically connected to battery via a connection line (wire) or electrical contact. In one embodiment, a buzzer (not shown) may be disposed on the brooch member 103 for coupling to the circuit board.

When the light emitting device 104 is activated, the brooch device 100 is then emitting light for illumination.

In one embodiment, the light emitting device 104 is embedded on the top surface of the brooch member 102. In one embodiment, the brooch member 103 defines/provides a battery compartment 105 configured to hold a miniature electric battery which provides the energy for the light emitting device 104 and the circuit board, shown in FIG. 3. In one embodiment, a metal sheet is mounted on backside of the brooch member 103. For example, the metal sheet locates within the battery compartment for electrical connection with the battery and the circuit board.

In one embodiment, control circuit on the circuit board is used for controlling the operation of the multiple LEDs housed within the housing 101. Control circuit is typically an integrated circuit and is programmed with one or more patterns for flashing and/or maintaining illumination of LEDs. The switch 106 is used to power on and power off (power source providing for) the light emitting device 104. The switch 106 may also be used to cycle through any number of different light patterns of the light emitting member 102. For example, each light emitting device (LED) 104 may be turned on for a fraction of a second in the sequential order as they are positioned inside of housing 101.

In one embodiment, the brooch device 100 further comprises a rock switch for coupling to the circuit board to determine electrical connection of the circuit board. The rock switch is for example ball-rolling switch, vibration ball switch or contact type vibration switch.

In another embodiment, the brooch device 100 further comprises a music IC for coupling to the circuit board. The rock switch is used to turn on electrical connection of the circuit board to activate the music IC and LEDs of the light emitting device 104.

In this embodiment, the brooch member 103 with light emitting member 104 is combined with (to be fixed for) the housing 101 and the decoration unit 102 to form the brooch device 100. For example, a bottom cover may be combined with (fixed to) or detachable from the brooch member 103.

The foregoing descriptions are preferred embodiments of the present invention. As is understood by a person skilled in the art, the aforementioned preferred embodiments of the present invention are illustrative of the present invention rather than limiting the present invention. The present invention is intended to cover various modifications and similar arrangements included within the spirit and scope of the appended claims, the scope of which should be accorded the broadest interpretation so as to encompass all such modifications and similar structures.

What is claimed is:

1. A brooch device having function of illumination, comprising:
a brooch member;
a light emitting device fixed on said brooch member;
a housing with transparent or translucent property surrounding said light emitting device; and
a switch coupled to said light emitting device for selectively power on and power off said light emitting device.

2. The brooch device of claim 1, further comprising a decoration unit disposed on said housing.

3. The brooch device of claim 1, wherein said light emitting member is a light emitting diode.

4. The brooch device of claim 1, further comprising a picture formed an inner surface or an outer surface of said housing.

5. The brooch device of claim 1, wherein said brooch member comprises a circuit board disposed on a bottom portion of said brooch member, wherein said circuit board includes a control circuit for controlling said light emitting device.

6. The brooch device of claim 5, further comprising a buzzer disposed on top surface of said brooch member for coupling to said circuit board.

7. The brooch device of claim 5, further comprising a rock switch for coupling to said circuit board.

8. The brooch device of claim 7, wherein said rock switch is ball-rolling switch, vibration ball switch or contact type vibration switch.

9. The brooch device of claim 7, further comprising a music IC for coupling to said circuit board.

10. The brooch device of claim 9, wherein said control circuit is an integrated circuit and is programmed with one or more patterns for flashing and/or maintaining illumination of said light emitting devices.

11. The brooch device of claim 9, wherein said brooch member includes a battery compartment.

12. The brooch device of claim 11, further comprising a battery disposed on said battery compartment.

13. The brooch device of claim 11, further comprising a bottom cover combined with or detachable from said brooch member.

14. The brooch device of claim 5, further comprising a music IC for coupling to said circuit board.

15. The brooch device of claim 14, wherein said control circuit is an integrated circuit and is programmed with one or more patterns for flashing and/or maintaining illumination of said light emitting devices.

16. The brooch device of claim 14, wherein said brooch member includes a battery compartment.

17. The brooch device of claim 16, further comprising a battery disposed on said battery compartment.

18. The brooch device of claim 16, further comprising a bottom cover combined with or detachable from said brooch member.

19. The brooch device of claim 1, wherein said brooch member comprises a fixing pin fixed thereon.
